(19) United States
(12) Patent Application Publication
(10) Pub. No.: US 2021/0291784 A1
(43) Pub. Date: Sep. 23, 2021

(54) VERIFYING NOVICE DRIVER SUPERVISION

(71) Applicant: International Business Machines Corporation, Armonk, NY (US)

(72) Inventor: Leonid Rodniansky, Allston, MA (US)

(21) Appl. No.: 16/824,035

(22) Filed: Mar. 19, 2020

(51) Int. Cl. B60R 25/045; B60R 25/25

(52) U.S. Cl. CPC B60R 25/045; B60R 25/257; B60R 25/255; B60R 25/252

(57) ABSTRACT

A blocking device and a computer-implemented method for preventing an ignition of a vehicle of a novice driver when a supervising driver is not present, the method includes one or more computer processors blocking an ignition circuit of a vehicle. The method includes one or more computer processors receiving a first biometric identification of a supervising driver from a biometric device and determining whether the first biometric identification matches a verified biometric identification of the supervising driver stored in a blocking device. Furthermore, responsive to determining that the first biometric identification matches the verified biometric identification of the supervising driver stored in the blocking device, the method includes one or more computer processors, unblocking the ignition circuit of the vehicle.

### BACKGROUND

The present invention relates generally to the field of computing devices for automotive vehicles, and more particularly for a computing device connected to an automotive vehicle to ensure the presence of a required supervising experienced driver with a new driver before starting the vehicle ignition.

In the United States and other countries, many states or providences may require the presence of a supervising experienced driver for a specified period of time when person becomes a new driver. Specific laws and regulations regarding allowed times of the day for a new driver and the age of a required supervising adult may vary from state to state, from city to city, or from country to country. In some states, a new driver requires supervision by an adult, for example, an experienced driver over the age of 21 during the hours between 5 am and 9 pm while restricting driving after 9 pm. Some localities, such as the boroughs of New York City, allow only supervision by a parent or a professional driving instructor. Other states only require new driver supervision of novice drivers during nighttime hours. These restrictions on new drivers may be removed at a certain age of the new driver or after the new driver of a specified age or a new driver within a range of ages has driven with supervision for a specified period of time.

### SUMMARY

Embodiments of the present invention include a method, computer program product, a computer system, and a device for preventing an ignition of a vehicle of a novice driver when a supervising driver is not present. The method, performed by one or more computer processors, blocks an ignition circuit of a vehicle. The method includes using an application to verify, with a computing device in a department responsible for issuing driver licenses, an age and license status of an experienced driver desiring to provide supervision to the novice driver. The method includes the one or more computer processors receiving a first biometric identification of a supervising driver from a biometric device. The method includes the one or more computer processors determining whether the first biometric identification matches a verified biometric identification of the supervising driver stored in a blocking device. Responsive to determining that the first biometric identification matches the verified biometric identification of the supervising driver stored in the blocking device, the method includes the one or more computer processors unblocking the ignition circuit of the vehicle.

### BRIEF DESCRIPTION OF THE DRAWINGS

FIG. 1 is a functional block diagram of a computing environment suitable for using a novice driver program in a blocking device to prevent operation of a vehicle by a novice driver without a supervising experienced driver, in accordance with at least one embodiment of the invention.

FIG. 2 is diagram depicting an example of a vehicle with a blocking device, in accordance with at least one embodiment of the invention.

FIG. 3 is a diagram depicting an example of the operation of the blocking device when a supervising experienced driver is not present, in accordance with at least one embodiment of the invention.

FIG. 4 is a diagram depicting an example of a one-time process to verify an experienced driver to supervise a novice driver, in accordance with at least one embodiment of the invention.

FIG. 5 is a diagram depicting an example of the blocking device verifying the presence of an experienced driver with a novice driver, in accordance with at least one embodiment of the invention.

FIG. 6 is a flow chart diagram depicting an example of operational steps of a clock module in the blocking device, in accordance with at least one embodiment of the invention.

FIG. 7 is a flow chart diagram depicting an example of operational steps of a novice driver program within the blocking device, in accordance with at least one embodiment of the invention.

FIG. 8 is a block diagram depicting components of a computer system suitable for executing the novice driver program, in accordance with at least one embodiment of the invention.

### DETAILED DESCRIPTION

Embodiments of the present invention recognize that various states, countries, and cities can have different regulations requiring experienced licensed adult supervision of a new or novice driver. Embodiments of the present invention recognize that these regulations require the supervising adult should be a pre-determined age, such as twenty-one years old, and that the supervision of the novice driver may be required for certain times of the day for a pre-determined length of time, such as six months, or until a teen driver has attained a certain age.

Embodiments of the present invention recognizes that enforcing laws requiring of the presence of a supervising adult driver is not generally done by law enforcement officials unless a traffic infraction involving the novice driver occurs. Embodiments of the present invention recognize that a method of ensuring that new drivers cannot drive a vehicle without proper adult supervision would improve road safety. Embodiments of the present invention recognize a device installed in a vehicle of a novice that can be pre-programmed specifically to match the regulations of the novice driver's state or locality to prevent the novice vehicle's ability to start without the presence of a supervising adult is desirable. Embodiments of the present invention recognize that installing or using a device to ensure the presence of an adult in a vehicle of a new or novice driver could be used to reduce car insurance associated with a novice driver. Furthermore, embodiments of the present invention recognize that a method to prevent unsupervised driving by a teen driver provides peace of mind to parents or guardians of novice drivers.

Embodiments of the present invention provide a method, computer program product, and a computer system for enforcing laws regarding supervision of a new driver or novice driver by an experienced adult driver when the new or novice drive is driving a vehicle. Embodiments of the present invention provide a blocking device with a program that is customizable to the specific regulations, such as an age of the supervising experienced driver, allowable times of the day for the new driver to operate the vehicle, and how long the new driver requires supervision for each state, country, or city of operation or registration of the vehicle of the new driver.

Embodiments of the present invention provide a blocking device installed in the vehicle of a new or novice driver allowing the vehicle to start only in the presence of a legally required experienced driver. The blocking device, installed in a vehicle of a novice driver, blocks the ability of the ignition system to start the car without a biometric verification of the presence of a verified experienced driver. Embodiments of the present invention of the present invention include a program within the blocking device that verifies the presence of a supervising adult using biometric identification data of the supervising driver received from one or more biometric devices in the novice driver's vehicle. Each time, before a novice driver can start the vehicle, the program in the blocking device requires receipt biometric identification data from a biometric device in the novice driver's vehicle that matches a stored Department of Motor Vehicles (DMV) verified experienced driver's biometric identification data (e.g., fingerprints) provided during a one-time verification process of the experienced driver.

Embodiments of the present invention require a one-time verification of a supervising adult driver using the DMV or other government operated entity controlling driver licensing, vehicle registration, and/or driver requirement. The verification can be obtained using a software application, downloaded to the supervising adult's mobile phone or device. The one-time verification of the supervising adult driver uses the application to request and receive the one-time verification of a current license status and a legally allowable age of the experienced driver desiring to supervise a new driver from the DVM.

Embodiments of the present invention the experienced driver, using the mobile phone software application, provides the verification from the DMV of the experienced driver to the program in the blocking device in the new driver's vehicle. After the experienced driver provides the DMV verification of age, the experienced driver provides to the blocking device his or her biometric identification data from a biometric device inside the passenger compartment of the new driver's vehicle to complete the one-time verification process of the experienced driver.

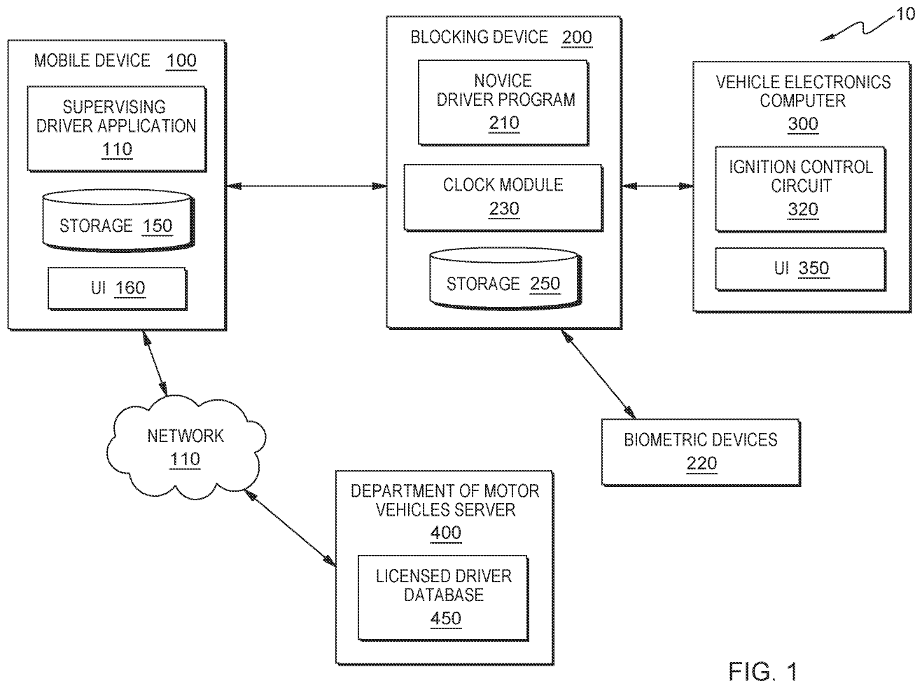

Referring now to various embodiments of the invention in more detail, FIG. 1 is a functional block diagram of a network computing environment, generally designated 10, suitable for operation of new driver program 210 in blocking device 200, in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims. For the purposes of the present invention describing an experience level of a driver of a vehicle, hereinafter, the term “new driver” and “novice driver” may be used interchangeably to describe a person just starting to drive a vehicle or with limited experienced driving.

Network computing environment 10 includes mobile device 100, blocking device 200, vehicle electronics computer (VEC) 300, and Department of Motor Vehicle (DMV) server 400 interconnected over a network, such as network 110. In embodiments of the present invention, network 110 can be a telecommunications network, a local area network (LAN), a wide area network (WAN), or a combination of the three, and can include wired, wireless, or fiber optic connections. Network 110 may include one or more wired and/or wireless networks that are capable of receiving and transmitting data, license numbers, token, digital image data such as fingerprint data, retinal images, or facial images, voice, and/or video signals, including multimedia signals that include voice, data, and video formation. In general, network 110 may be any combination of connections and protocols that will support communications between mobile device 100, blocking device 200, VEC 300, DMV server 400, and other computing devices (not shown) within network computing environment 10.

Mobile device 100 is a mobile computing device. In various embodiments, mobile device 100 includes a smart phone, a wearable computer such as a smart watch, smart glasses or goggles, a hand-held device such as a tablet, or any other mobile computing device. In other embodiments, mobile device 100 includes a laptop computer, a notebook computer, an e-reader, or other movable computing device capable of connecting to novice driver program 210 in blocking device 200 and DMV server 400. In various embodiments, mobile device 100 includes one or more of fingerprint scanners, a camera, retinal scanner, audio recording, or other known identification apparatus or functions used in mobile devices. In one embodiment, mobile device 200 connects to vehicle electronic computer system (VECS) 300. In an embodiment, mobile device 100 is a desktop computer capable with a program of connecting with novice driver program 210 in blocking device 200 and DMV server 400 for the one-time DMV verification of the supervising experienced driver.

In general, mobile device 100 represents any programmable electronic device or combination of programmable electronic devices capable of executing machine readable program instructions and communicating with other computing devices (not shown) within computing environment 10 via a network, such as network 110. In various embodiments of the invention, mobile device 100 includes supervising driver application 101, storage 150, and user interface (UI) 160. User Interface (UI) 160 in mobile device 100 can be a touch screen and may include fingerprint scanning technology or retinal scanning technology as may be used for mobile device 100 security and access control. UI 160 can be any known type of user interface and include any known technological features of mobile device user interfaces. In various embodiments, mobile device 100 connects wirelessly to blocking device 200.

In various embodiments, supervising driver application 101 in mobile device 100 includes software instructions and/or computer code to send a request and experienced driver identification information (e.g., license number, social security number, etc.) to DMV server 400 for a one-time verification of a current license and a legally required age of the experienced driver (e.g., according to legal requirements of the current locality—state, city, or country—where the new or novice driver resides). In various embodiments, supervising driver application 101 sends the DMV verification of the experienced driver to blocking device 200 and may store the received verification of experienced driver's license status and age in storage 150 in mobile device 100. In various embodiments, supervising driver application 101 is downloaded to mobile device 100 from an application store, DMV server 400, a DMV website, a vehicle manufacturer website, or any other applicable source of providing supervising driver application 101.

In one embodiment, the computer code and functionality of supervising driver application 101 is integrated into VEC 300. In this embodiment, the request for experienced driver verification is sent to DMV server 400 over network 110 by a supervising driver program in VEC 300. Entered experienced identification including fingerprint and/or facial image capture occurs in one or more of: a vehicle user interface, an interior vehicle camera, or the like in the vehicle after completion of the DMV verification.

In various embodiments, blocking device 200, in a novice driver's vehicle, is connected to mobile device 100, biometric devices 220, VEC 300, and DVM server 400. Blocking device 200, using novice driver program 210, prevents the start of the engine of the novice driver's vehicle by blocking the ignition of the novice driver's vehicle when a DMV verified, experienced driver of sufficient age is not present. In various embodiments, blocking device 200 is wired to ignition control circuit 320 in VEC 300 and to one or more biometric devices 220 in the novice driver's vehicle. In various embodiments, blocking device 200 is installed or inserted into the ignition control circuit 320 before the starter of the vehicle.

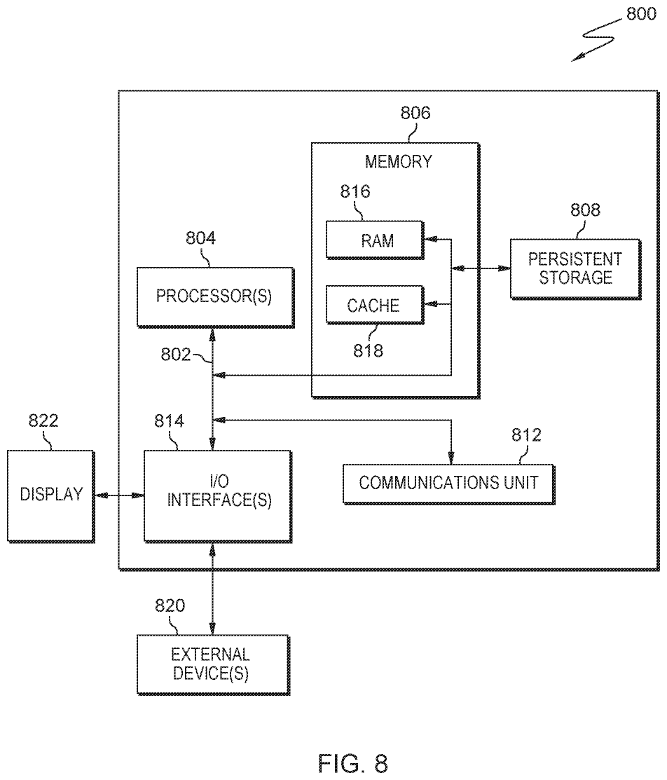

In various embodiments, blocking device 200 connects with mobile device 100, biometric devices 220, and VEC 300 directly using a wireless or a wireless ad hoc network (WANET), mobile ad hoc network (MANET), Bluetooth, or a limited range small area network as decentralized wireless networks. In some embodiments, blocking device 200 includes a user interface (not depicted) to display a status of blocking device 200 (e.g., enabled or disabled). In various embodiments, blocking device 200 includes the functionally of a computer system, such as computer system 800 (depicted in FIG. 8). In various embodiments, blocking device 200 includes novice driver program 210, clock module 230, storage 250, and biometric devices 220.

In various embodiments, blocking device 200 is a device installed by a dealer or repair shop as an after-purchase feature or device. In various embodiments, blocking device 200 includes biometric devices 220. In various embodiments, biometric devices 220 are installed in a front seat passenger accessible portion of the novice driver's vehicle, such as a dashboard area, as a part of blocking device 200.

In an embodiment, blocking device 200 is a feature or an option in a new car. In one embodiment, the functionality, hardware, and programming code of blocking device 200, biometric devices 220, and novice driver program 210 are standard features provided in a new vehicle. In this embodiment, novice driver program 210, biometric devices 220, and blocking device 200 are integrated into VEC 300 (e.g., the vehicle's computer system and software) and mechanical systems of the novice driver's vehicle as manufactured or purchased.

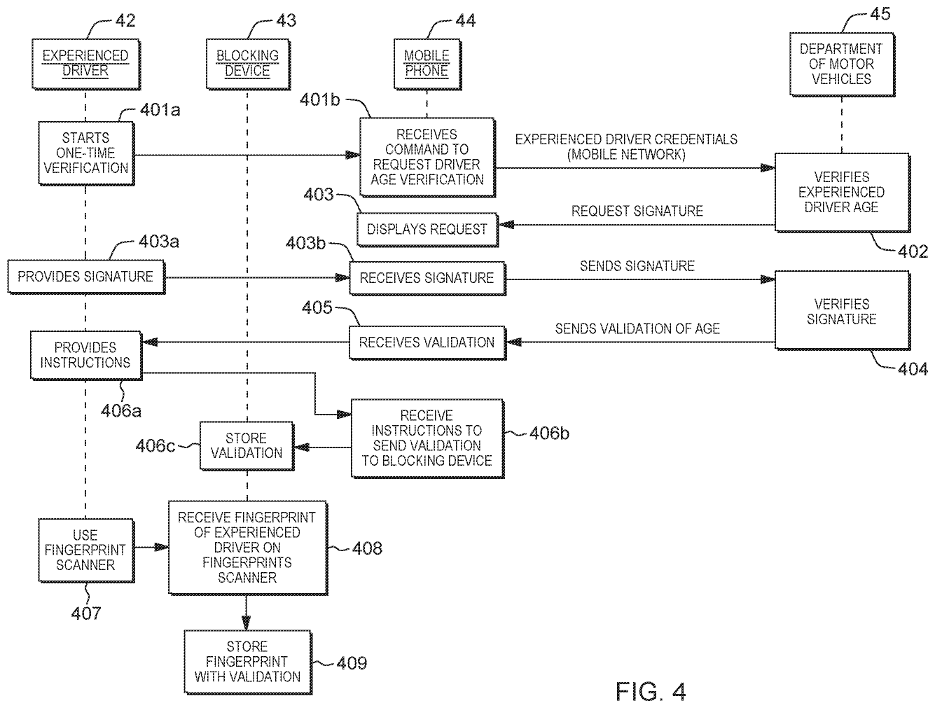

In various embodiments, novice driver program 210 in blocking device 200 blocks the vehicle engine from starting using ignition control circuit 320 in VEC 300. Each time before a novice driver wishes to start a vehicle with blocking device 200, novice driver program 210 requires receipt of a DMV verified experienced driver's biometric identification data (e.g., fingerprints) to determine if current biometric identification data received from biometric devices 220 in the vehicle matches the stored, previously received experienced driver identification data provided to blocking device 200 during the one-time verification process with the DMV discussed in detail later with respect to FIG. 4. Novice driver program 210 can receive from supervising driver application 101 and store the DMV verification of experienced drivers who are of an age to provide legal supervision of a novice driver. In various embodiments, novice driver program 210 receives and stores, in storage 250, biometric identification data, such as fingerprint scans, retina scans, or facial images, associated with the DMV verified experienced driver from biometric devices 220 (e.g., as a part of a one-time verification process). In various embodiments, new driver program 210 receives stores both DMV verification of licensing status and age from mobile device 100 along with experienced driver biometric identification data, such as the experienced driver's fingerprint received from a fingerprint scanner and or other biometric identification data from biometric device 220 during the one-time verification process. In one embodiment, novice driver program 210 receives and stores one or more of experienced driver's facial image, fingerprints, voice, or retinal scan data from DMV server 400 along with the verification of licensee status and age of the experienced driver.

In another embodiment, novice driver program 210 resides in mobile device 100 along with supervising driver application 101. In this embodiment, blocking device 200 blocks ignition control circuit 320 until receiving a command from novice driver program 210 in mobile device 200 to unblock the ignition control circuit 320. Then biometric device 220 along with storage 250 resides on mobile device as well.

In another embodiment, novice driver program 210 is included in mobile device 100 and blocking device 200 is not present. In this embodiment, mobile device 100 provides the functionality of blocking device 220 and includes supervising driver application 101. For example, mobile device 100, using novice driver program 210, can send a command to ignition control circuit 320 in VEC 300 to block the novice driver's vehicle start and send another command to ignition control circuit 320 to unblock the ignition to allow the novice driver's vehicle to start when a DMV verified experienced driver is present. Mobile device 100 can store DMV verification of the experienced driver provided by supervising driver application 101, can capture and/or receive experienced driver biometric data of the DMV verified experienced driver for storage, can use novice driver program 210 to determine if currently received or new biometric data of an experienced driver in the vehicle matches a stored biometric data of a previously DMV verified experienced driver, and then, can send a command to unblock the vehicle's ignition. In this embodiment, mobile device 100 connects wirelessly to ignition control circuit 320 in VEC 300 and uses novice driver program 210 to block and then, to unblock ignition control circuit when a DMV verified experienced is present (e.g., when new biometric data matches stored biometric data).

Additionally, in some embodiments, mobile device 100 provides the biometric identification of the experienced driver to novice driver program 210 using known security applications and/or built-in functions. For example, mobile device 100 can use fingerprint recognition, retinal scan recognition, or facial recognition, to capture biometric identification data, such as fingerprints, facial images, or retinal scans of an experienced driver. Novice driver program 210 in mobile device 100 can compare new and stored fingerprints, retinal scans and facial images to determine matches in order to unblock a vehicle's ignition. In some embodiments, a proximity sensor, a passenger seat sensor, or other similar known method of verifying that the experienced driver using mobile device 100 is present in the novice driver's vehicle may be used.

In various embodiments, biometric data devices 220 are one or more external or remote devices in the novice driver vehicle connected to blocking device 200. In various embodiments, biometric devices 220 include one or more of a fingerprint scanner, a camera, an audio recorder, or a retinal scanner. In one embodiment, one of biometric devices 220 can be a fingerprint scanner present in the passenger side interior or passenger side dashboard of the novice driver's vehicle. In another example, retinal scans are captured from one of biometric devices 220 that are augmented reality smart glasses, a heads-up display, an in-vehicle retinal scanner, or the like. When a novice driver desires to drive the vehicle, the supervising experienced driver uses the fingerprint scanner to provide fingerprint data sent to novice driver program 210 to verify that a DMV approved supervisory experienced driver is present in the vehicle. The fingerprint scanner sends the fingerprint data to novice driver program 210 in blocking device 200. In one embodiment, one or more of a fingerprint scanner, interior camera, an audio recording device, or retinal scanner interior to the novice driver's vehicle can provide experienced driver biometric identification data to novice driver program 210. Biometric devices 220 may be present in the interior of the novice driver's vehicle in location easily accessible from the passenger seat. In one embodiment, biometric devices 220 are included in a new vehicle and integrated with VEC 300 when novice driver program 210 is a feature included in a new vehicle. In other embodiments, biometric devices 220 are installed with blocking device 200 after vehicle purchase.

In various embodiments, clock module 230 is included in blocking device 200. Clock module 230 tracks the time elapsed since the first initiation of new driver program 210 in blocking device 200. In some embodiments, clock module 230 tracks the time of day. Clock module 230 can be a clock chip. In various embodiments, novice driver program 210 monitors clock module 230 to verify either the time of day or the time elapsed from a first start of a vehicle using novice driver program 210.

In various embodiments, storage 250 in blocking device 200 stores the DMV verification of experienced driver license status and age provided by mobile device 100 during the one-time verification of each experienced driver supervising the novice driver. For example, storage 250 stores experienced driver biometric identification data, such as fingerprints, received during the one-time experienced driver verification process from biometric devices 220. In one embodiment, storage 250 receives and stores together both the DMV verification and experienced driver identification biometric data generated by mobile device 100 during the experienced driver one-time verification process.

In various embodiments, vehicle electronics computer (VEC) 300 is a computer or a computer system with a vehicle controlling the various electrical and mechanical functions of the vehicle. As depicted, VEC 300 includes ignition control circuit 320 and UI 350. In various embodiments, blocking device 200 is hardwired or wirelessly connected to VEC 300 to block and unblock the vehicle's start.

In some embodiments, VEC 300 includes the function of blocking device 200, novice driver program 210, and biometric devices 220. In this case, the wireless connections (not depicted in FIG. 1) from VEC 300 to network 110, mobile device 100, and DMV server 400 are utilized by novice driver program 210 in VEC 300.

In various embodiments, DMV server 400 includes licensed driver database 450. DMV server 400 connects to mobile device 100 over network 110. In various embodiments, DMV server 400 receives requests for driver license status and age from mobile device 100. In an embodiment, DMV server 400 receives requests for driver license status and age from novice driver program 210 in VEC 300. In various embodiments, DMV server provides a verification of a driver's license status and age to one of mobile device 100 or VEC 300. DMV server 400 may utilize one or more of known database search programs, facial recognition programs, fingerprint recognition programs, or retinal scan recognition programs during verification of a driver license status and age.

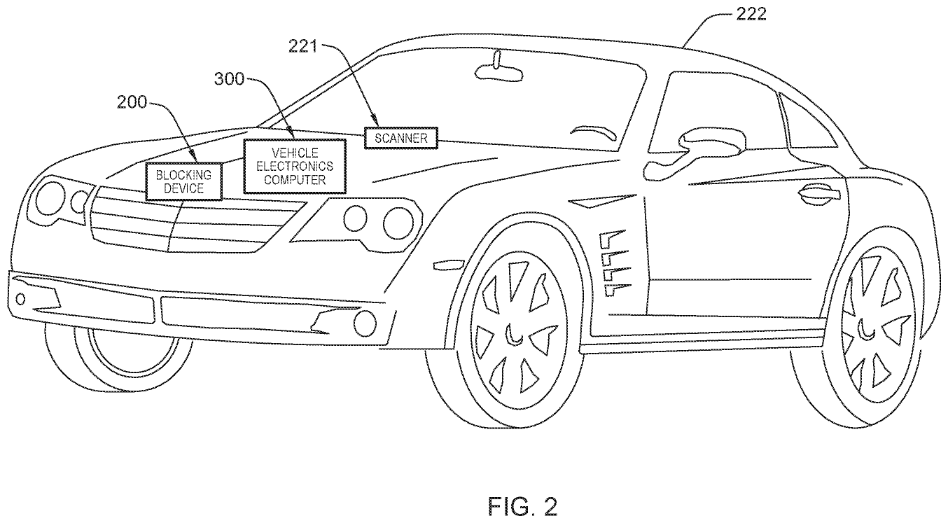

FIG. 2 is diagram depicting an example of vehicle 222 with blocking device 200, in accordance with at least one embodiment of the invention. As depicted in FIG. 2, blocking device 200 and scanner 221 may reside in vehicle 222. Blocking device 200 may reside in the engine compartment area of vehicle 222. In various embodiments, scanner 221 which is one of biometric devices 220, is present in the interior of vehicle 222 on a front passenger side of vehicle 222. Scanner 221 can be a fingerprint scanner, a retinal scanner, or in some embodiments, a camera.

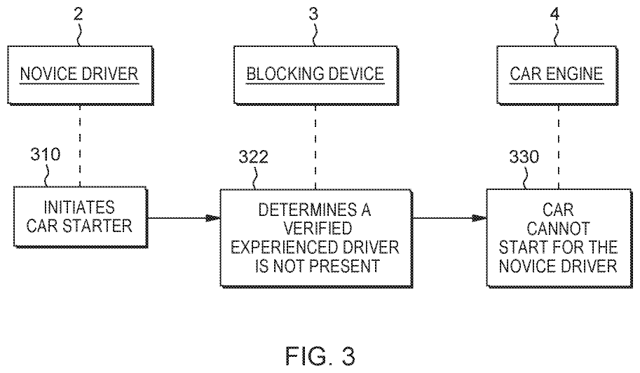

FIG. 3 is a diagram depicting an example of the operation of blocking device 3 when a supervising experienced driver is not present, in accordance with at least one embodiment of the invention. Blocking device 3 with novice driver program 210 (not depicted) provides the same or virtually the same functions as blocking device 200 in FIG. 1. When installed in car engine 4, blocking device 3 blocks the vehicle ignition circuit from starting in car engine 4. In block 310, novice driver 2 initiates car starter. In block 322, blocking device 200 determines a verified experienced driver is not present when no DMV verified experienced driver biometric data is received. The vehicle ignition remains blocked and car engine 4 cannot start for novice driver 2 in block 330. Blocking device 200 maintains the block on starting car engine 4 when a DMV verified supervising, experienced driver does not provide a biometric identification, such as a fingerprint, to a biometric device inside the car to blocking device.

FIG. 4 is a diagram depicting an example of a one-time process to verify experienced driver 42 to supervise a novice driver, in accordance with at least one embodiment of the invention. FIG. 4 depicts an example of the one-time verification process of experienced driver 42 using Department of Motor Vehicles (DMV) 45 and mobile device 44, where mobile device 44 can be a mobile device similar to mobile device 100 in FIG. 1 and DMV 45 can use DMV server 400 (depicted in FIG. 1). Blocking device 43 using a program, such as novice driver program 210 (depicted in FIG. 1) provides the same or virtually the same functions as blocking device 200 in FIG. 1. In order for blocking device 43 to unblock the vehicle ignition circuit to start the engine, an experienced driver must first, in a one-time process, verify with the DMV or other required governmental entity responsible for licensing drivers and maintaining new driver regulations both his or her license status (i.e., a licensed driver) and an age sufficient or old enough to legally provide supervision of a new or novice driver.

In various embodiments, experienced driver 42 starts the one-time verification process (block 401a) by providing a command to mobile device 44. Mobile device 44 receives command to request a driver age verification from DMV 45 in block 401b. Experienced driver 42 inputs one of more of the following credentials: driver license number, social security number, a digital facial image captured on mobile device 44, a passport, number, or any other state or federally recognized identification from experienced driver 42 available to DMV 45. Mobile device 44 using a software application, such as supervising driver application 101 (not depicted in FIG. 4), provides to DMV 45 over a mobile network the experienced driver's credentials and the request for verification of experienced driver 42's license status and verification that the experienced driver 42's age is suitable for legal supervision of a novice driver according to DMV regulations for the locality.

In block 402, DMV 45 verifies experienced driver 42's age and license status by querying a licensed driver database or other similar DMV license data repository. In some embodiments, DMV 45 requests a confirmation of experienced driver 42's identification by sending to mobile device 44 a request a signature from experienced driver 42 as further identification verification. Mobile device 44 may display the received signature request from DMV 45 to experienced driver 42 in block 403. In response, experienced driver 42 provides a signature in block 403a, for example, by signing touch screen on mobile device 44 or taking a picture of his or her signed license. Mobile device 44 using supervising driver application 101, for example, receives the signature in block 403b and sends it to DMV.

DMV 45, using known methods, verifies the signature of experienced driver 45 in block 404. DMV 45 sends the validation of experienced driver 42's age for legally supervising a novice driver to supervising driver application 110 in mobile device 44. The validation of experienced driver 42 verifying experienced driver 42 as a legal supervising adult may be provided as one or more of the following: a token, an age, a statement such as “approved supervisory adult,” a credential, a yes or a no, a code, or any other pre-determined method for DMV 45 to communicate a verified acceptability on experienced driver 42 as a legally supervising driver for a novice driver. In block 405, mobile device 44 receives the validation from DMV 45. Experienced driver 42 provides instructions to mobile device 44 in block 406a to send the validation to blocking device 43. Using supervising driver application 110, mobile device 44 sends DMV validation to blocking device 43 in block 406b. Blocking device 43 stores the DMV verification in block 406c.

After receiving the DMV verification of experienced driver 42's age and driver's license, experienced driver 42 uses a biometric device in the interior compartment of the car of a novice driver to send biometric identification data, such as, a fingerprint using a fingerprint scanner to blocking device 43 in block 407. In various embodiments, the biometric device in the passenger side of a novice driver's vehicle connects to blocking device 43. Blocking device 43 receives experienced driver 42's biometric identification data, such as a fingerprint from scanner 221 (depicted in FIG. 2) or another type of biometric identification data (e.g., facial image, etc.) in block 408.

In one embodiment, the biometric identification data, such as the fingerprint from block 407, is scanned by mobile device 44 and sent to blocking device 43. In this embodiment, mobile device 44 using one of known fingerprint scanning, facial photographs, voice recording, or retinal scans, for example from augmented reality smart glasses, a heads-up display or the like, sends experienced driver 42's biometric identification data to blocking device 43. In one embodiment, blocking device 43 receives fingerprint data from mobile device 43 identified as in an immediate proximity of the car dash sensors (e.g., within the car).

In block 409, blocking device 43 receives and stores experienced driver 42's fingerprint or other biometric identification data with the DMV validation or one-time verification of experienced driver 42 as a supervising experienced driver.

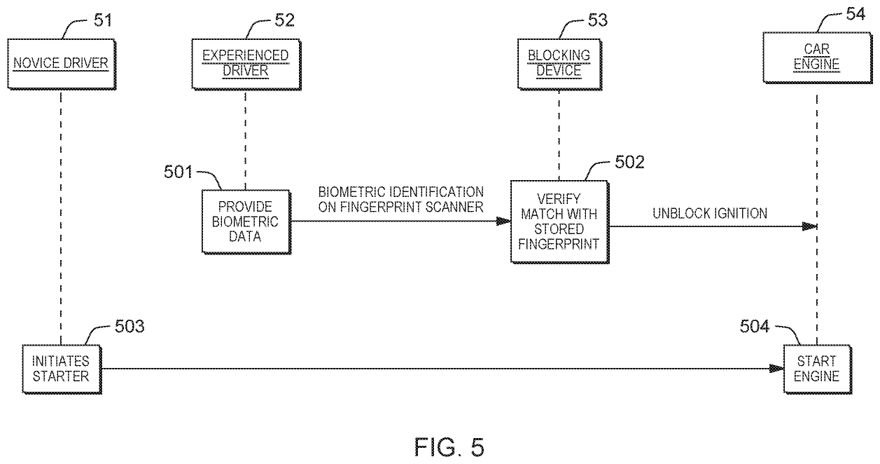

FIG. 5 is a diagram depicting an example of blocking device 53 verifying the presence of experienced driver 52 with novice driver 51, in accordance with at least one embodiment of the invention. Blocking device 53 using novice driver program 210 (not depicted) provides the same or virtually the same functions as blocking device 200 in FIG. 1. Experienced driver 52 has completed the same one-time verification process as discussed in detail with respect to FIG. 4 and is therefore, a DMV verified experienced driver who can provide legal supervision of novice driver 51.

As previously discussed, blocking device 53 blocks car engine 54 from starting unless novice driver program 210 (not depicted in FIG. 5) in blocking device 53 receives biometric identification of an experienced driver who is a DMV approved or DMV verified experienced driver. In order for novice driver 51 to start car engine 54, experienced driver 52 must provide biometric data, such as a fingerprint captured on scanner 221 (depicted in FIG. 2). In block 501, experienced driver 52 provides biometric data to blocking device 53, for example, using a fingerprint scanner (e.g., scanner 221 in FIG. 2).

In block 502, blocking device 53, using novice driver program 210, verifies a match of the fingerprint captured on scanner 221, for example, with the stored fingerprint of a DMV verified experienced driver 52 in blocking device 53. In various embodiments, the stored fingerprint of experienced driver 52 is the fingerprint stored as a part of the previously performed DMV verification of experienced driver 52 as a legal supervisor of a novice driver (e.g., as previously discussed with respect to FIG. 4). Upon verifying the match of experienced driver 52's fingerprint from scanner 221 to one of the fingerprints of DMV verified experienced drivers stored in blocking device 53, blocking device 53, using novice driver program 210, unblocks the ignition of car engine 54.

After experienced driver 52 provides verified biometric data, such as a fingerprint, to blocking device 53 matching a stored fingerprint of a DMV verified experienced driver, in block 503, novice driver 51 initiates the starter. Car engine 54 with unblocked ignition circuit starts in block 504.

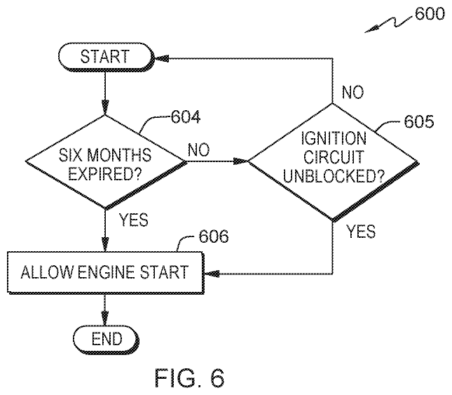

FIG. 6 is a flow chart diagram depicting an example of operational steps 600 of novice driver program 210 in blocking device 200 (depicted in FIG. 1) using a clock circuit, in accordance with at least one embodiment of the invention. In various embodiments, the clock circuit is in clock module 230 (depicted in FIG. 1) included as a part of blocking device 200. The clock circuit in clock module 230 can track the time elapsing from the first initiation of blocking device 200 by a novice driver attempting to starting the car. In one embodiment, clock module 230 includes instructions to unblock the ignition and disengage the blocking device 200 by ending novice driver program 210 after the legally required time for supervision has pasted (e.g., six months for the example depicted in FIG. 6). Each time a novice driver attempts to start the vehicle, while blocking device 200 and novice driver program 210, are engaged, clock circuit in clock module 230 is checked to see if supervision of the novice driver is required.

In various embodiments, one or more of novice driver program 210 and clock module 230 is pre-set with the legally required time for supervision of a new driver by an experienced driver. For the purpose of illustration in FIG. 6, the legally required time for supervision of the novice driver is six months, although in other examples, the legally required time for supervision could another length of time, such as, a year. A required supervision time of six months can be either pre-loaded in in novice driver program 210 in blocking device 200 or programmed during blocking device 200 installation.

In decision step 604, novice driver program 210 determines whether six months have expired. In various embodiments, each time a novice driver attempts to start the vehicle, novice driver program 210 queries clock module 230 to verify the amount of time that has passed since the first request to start the vehicle with blocking device 200. In one embodiment, novice driver program 210 queries clock module 230 on a pre-determined time interval (e.g., every day).

Responsive to determining that six months have not expired (no branch of decision step 604), novice driver program 210 determines if the ignition circuit is unblocked in decision step 605. If six months not passed, then novice driver program 210, in the next steps, will depend on the current state of the blocking device 200. For example, if in step 605, the ignition circuit is in unblocked state, then the novice driver will be allowed to start engine in step 606. Alternatively, if in step 605, the ignition circuit is in a blocked state, then novice driver has to wait while experienced driver unblocks ignition circuit. In an embodiment, novice driver program 210 can query ignition control circuit 320 (depicted in FIG. 1) to determine if the ignition circuit is unblocked.

Responsive to determining that the ignition circuit is unblocked (yes branch of decision step 604), novice driver program 210 allows the engine to start in step 606. In this case, novice driver program 210 in blocking device 200 has determined that a DMV verified experienced driver is present and has unblocked the ignition. In this step, when novice driver program 210 has determined the legally required supervision time for the novice driver is not over and the ignition circuit is unblocked, the program ends until another request to start the vehicle is received.

Responsive to determining that six months have expired (yes branch of decision step 604), novice driver program 210 allows the engine to start in step 606. In various embodiments, upon determining that the legally required supervision time for the novice driver has passed, novice driver program 210 allows the engine to start and the program ends. In some embodiments, when novice driver program 210 determines that the six months have expired, novice driver program 210 leaves the ignition unblocked and the program disengages blocking device 200. In one embodiment, novice driver program 210 sends a signal to VEC 300 in the car to display a message in UI 350 (depicted in FIG. 1) indicating that blocking device 200 is no longer needed for the novice driver and may be removed.

In another embodiment, clock module 230 includes instructions to unblock the ignition and disengage novice driver program 210 and blocking device 200 after the legally required time for novice driver supervision has expired. In this case, clock module 230 may end or turn off novice driver program 210 after the legally required time for supervision has pasted (e.g., six months for the example depicted in FIG. 6). The novice driver's vehicle can start without using novice driver program 210 as the novice driver no longer requires supervision (e.g., the ignition is unblocked). In some cases, blocking device 200 may be removed after the legally required time of supervision is over. In one embodiment, blocking device 200 and novice driver program 210 may be re-started or re-engaged by a certified technician if the vehicle is used later by another novice driver, such as a younger sibling.

In some embodiments, clock module 230 keeps track of the time of day (e.g., 2 pm, 10 pm, etc.) In these embodiments, novice driver program 210 can be configured with any specific times of day when novice drivers have limitations on driving or requires experienced driver supervision, based on, the state or locality. For example, some states only require novice driver supervision at night (e.g., 7 pm to 5 am, for example) while other states restrict novice driver driving after 9 pm. The restrictions for the state or locality can be configured at purchase and installation of either blocking device 200 or when the novice driver's vehicle is purchased. In these embodiments, novice driver program 210 queries clock module 230 for the time of day upon receiving a request to start the engine (e.g., each time novice driver program 210 has to check that a DMV verified experienced driver is present). In this embodiment, novice driver program 210 first verifies that the time of day is a time of day needs an experienced driver to supervise before verifying the presence of a DMV verified driver. If it is a time of day when the novice driver does not need supervision to drive, novice driver program 210 unblocks the ignition. Conversely, if it is a time of day when the novice driver is prohibited from driving, novice driver program 210 maintains the engine ignition block. In an embodiment, a licensed installer of blocking device 200 configures novice driver program 210 with special hours based, on legal documentation of special circumstances (e.g., night job, evening classes, or other special circumstances allowing non-supervised or after hours driving).

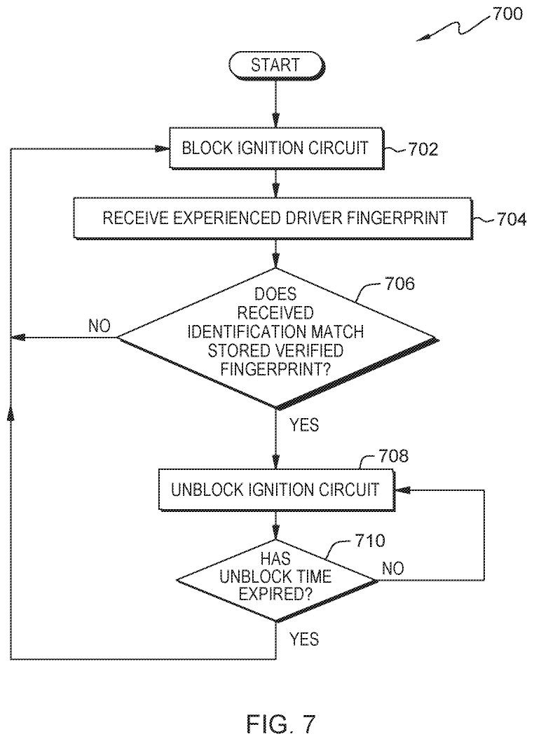

FIG. 7 is a flow chart diagram depicting an example of operational steps 700 of novice driver program 210 within blocking device 200, in accordance with at least one embodiment of the invention. In various embodiments, novice driver program 210 (depicted in FIG. 1) within blocking device 200 (depicted in FIG. 1) determines when an experienced driver of a legally appropriate age to supervise a novice driver is present in the vehicle of the novice driver.

In various embodiments, novice driver program 210 blocks the ignition circuit from starting the novice driver's car in step 702. In various embodiments, novice driver program 210 initially blocks the novice driver's car engine ignition system upon installation by not allowing electrical access to the engine starter. Novice driver program 210 in blocking device 200 may use ignition control circuit 320 to block novice driver's car from starting.

Novice driver program 210 receives the experienced driver's fingerprint in step 704. In various embodiments, novice driver program 210 receives from one of biometric devices 220 biometric identification data, such as, a fingerprint from scanner 221 (depicted in FIG. 2) as identification data. Other examples of biometric identification data received from biometric devices 220 include facial image data, voice recording data, or retinal scan data. In one embodiment, novice driver program 210 receives biometric identification data from mobile device 100. In another embodiment, novice driver program 210 in VEC 300 receives biometric data from biometric devices 220.

In various embodiments, novice driver program 210 determines if the received identification data matches the stored identification data in decision step 706. In this step, novice driver program 210 compares received fingerprint to the stored verified fingerprints of the DMV verified experienced drivers that are stored in storage 250 of blocking device 200 during the one-time verification of each supervising driver as discussed previously with respect to FIG. 4. In various embodiments, the received biometric identification data, such as fingerprints, from scanner 221 or any other of biometric devices 220 in the passenger side of the car are compared to the stored biometric identification data previously provided by one or more DMV verified experienced drivers during the one-time verification process of each experienced driver desiring to provide supervision to the novice driver. The stored biometric identification data, such as fingerprints, are provided to novice driver program 210 by each experienced driver desiring to supervise the novice driver during the one-time experienced driver verification process using the DMV (e.g., FIG. 4).

In various embodiments, novice driver program 210 determines whether the provided biometric identification data, such as a fingerprint of the experienced driver, matches a fingerprint of one of the fingerprints of one or more of the DMV verified experienced drivers that are stored within storage 250 of blocking device 200. In various embodiments, novice driver program 210 can use known fingerprint analysis algorithms to compare the provided fingerprints to the fingerprints of the DMV verified experienced drivers in storage 250. In some embodiments, novice driver program 210 compares received biometric data such as facial images, voice data, or retinal scans using one of known facial recognition, voice recognition, or retina recognition software or programs.

Responsive to novice driver program 210 determining in step 706 that the received identification data, such as a fingerprint, provided by one of biometric devices 220 does not match the previously stored identification data (no branch of decision step 706), such as a stored fingerprint of one of the DMV verified experienced drivers then, novice driver program 210 returns to step 702 and the car ignition circuit remains blocked. In this case, the novice driver will not be able to start the car.

In step 708, responsive to novice driver program 210 determining that the received identification data matches one of the previously stored identification data of a DMV verified experienced driver (yes branch of decision step 706) then, novice driver program 210 unblocks the car ignition circuit in step 708 so that the car can be started by the novice driver.

Novice driver program 210 determines whether the unblock time has expired in decision step 710. The unblock time can be a pre-set time that the car ignition can remain unblocked, such as, three or five minutes. In various embodiments, novice driver program 210 includes a pre-set time or unblock time for allowing the ignition circuit to remain unblocked after verifying the presence of a DMV verified experienced driver. For example, novice driver program 210 allows the car's ignition circuit to remain unblocked for three minutes after the determination to unblock the ignition circuit is made in step 706 (e.g., when a received fingerprint of an experienced driver matches a stored fingerprint of one of the DMV verified experienced drivers). Novice driver program 210 includes the pre-set time unblock time, such as three minutes, to leave the ignition circuit unblocked so that the experienced driver does not inadvertently leave the car with the engine unblocked. In this way, once the ignition is unblocked and the car is started, novice driver program 210 in blocking device 200 re-blocks the ignition of the running car such that when the novice driver turns off the engine, he or she must re-verify that a DMV verified experienced driver is present to re-start the car (i.e., the program returns to step 702 once the unblock time expires). In various embodiments, novice driver program 210 utilizes clock module 230 in FIG. 1 to monitor the unblock time and determine when the unblock time is over.

Responsive to novice driver program 210 determining that the pre-set time has expired (yes branch of decision step 710) then, novice driver program 210 returns to step 702 and blocks the ignition circuit.

Responsive to novice driver program 210 determining that the pre-set time has not expired (no branch of decision step 710) then, novice driver program 210 returns to step 708 and the ignition circuit remains unblocked. In this case, when the pre-set time has not expired, the ignition circuit remains unblocked and the novice driver can start the car.

In another embodiment, novice driver program 210 further ensures the presence of the DMV verified driver in the car before and after unblocking the car engine by monitoring the passenger seat sensor system in VEC 300. In this embodiment, novice driver program 210 verifies that the passenger seat is occupied during step 708 by querying passenger seat sensor system in VEC 300 to verify a person is sitting in the passenger seat. In an embodiment, novice driver program 210 continues to monitor, for example, every fifteen minutes, the passenger seat sensor to verify that the passenger seat sensor does not indicate that the passenger seat has been vacated until the car engine is turned off. If the passenger seat sensor indicates that the seat has been vacated after step 708 (i.e., unblocking ignition circuit), novice driver program 210 re-blocks the ignition circuit (i.e., novice driver program 210 sends a command to VEC 300 to turn off the engine when the passenger seat is vacated).

FIG. 8 is a block diagram depicting components of a computer system 800 suitable for executing novice driver program 210 in blocking device 200, in accordance with at least one embodiment of the invention. FIG. 8 displays the computer system 800, one or more processor(s) 804 (including one or more computer processors or central processor units), a communications fabric 802, a memory 806 including, a RAM 816, and a cache 818, a persistent storage 808, a communications unit 812, I/O interfaces 814, a display 822, and external devices 820. It should be appreciated that FIG. 8 provides only an illustration of one embodiment and does not imply any limitations with regard to the environments in which different embodiments may be implemented. Many modifications to the depicted environment may be made.

As depicted, the computer system 800 operates over the communications fabric 802, which provides communications between the computer processor(s) 804, memory 806, persistent storage 808, communications unit 812, and input/output (I/O) interface(s) 814. The communications fabric 802 may be implemented with an architecture suitable for passing data or control information between the processors 804 (e.g., microprocessors, communications processors, and network processors), the memory 806, the external devices 820, and any other hardware components within a system. For example, the communications fabric 802 may be implemented with one or more buses.

The memory 806 and persistent storage 808 are computer readable storage media. In the depicted embodiment, the memory 806 comprises a random-access memory (RAM) 816 and a cache 818. In general, the memory 806 may comprise any suitable volatile or non-volatile one or more computer readable storage media.

Program instructions for novice driver program 210 may be stored in the persistent storage 808, or more generally, any computer readable storage media, for execution by one or more of the respective computer processors 804 via one or more memories of the memory 806. In an embodiment, program instructions for lock management program 120 may be stored in memory 806. The persistent storage 808 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 808 may also be removable. For example, a removable hard drive may be used for persistent storage 808. Other examples include optical and magnetic disks, thumb drives, and smart cards that are inserted into a drive for transfer onto another computer readable storage medium that is also part of the persistent storage 808.

The communications unit 812, in these examples, provides for communications with other data processing systems or devices. In these examples, the communications unit 812 may comprise one or more network interface cards. The communications unit 812 may provide communications through the use of either or both physical and wireless communications links. In the context of some embodiments of the present invention, the source of the various input data may be physically remote to the computer system 800 such that the input data may be received, and the output similarly transmitted via the communications unit 812.

The I/O interface(s) 814 allow for input and output of data with other devices that may operate in conjunction with the computer system 800. For example, the I/O interface 814 may provide a connection to the external devices 820, which may be a fingerprint scanner, a digital camera, another biometric device, a keyboard, keypad, a touch screen, or other suitable input devices. External devices 820 may also include portable computer readable storage media, for example thumb drives, portable optical or magnetic disks, and memory cards. Software and data used to practice embodiments of the present invention may be stored on such portable computer readable storage media and may be loaded onto the persistent storage 808 via the I/O interface(s) 814. The I/O interface(s) 814 may similarly connect to a display 822. The display 822 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for preventing an ignition of a vehicle of a novice driver when a supervising driver is not present, the method comprising:
blocking, by one or more computer processors, an ignition circuit of a vehicle;
receiving, by one or more computer processors, a first biometric identification of a supervising driver from a biometric device;
determining, by one or more computer processors, whether the first biometric identification matches a verified biometric identification of the supervising driver stored in a blocking device; and
responsive to determining that the first biometric identification matches the verified biometric identification of the supervising driver stored in the blocking device, unblocking, by one or more computer processors, the ignition circuit of the vehicle.

2. The computer-implemented method of claim 1, wherein the verified biometric identification of the supervising driver stored in the blocking device is received as a part of a one-time verification of the supervising driver from a department of motor vehicles.

3. The computer-implemented method of claim 2, wherein the one-time verification of the supervising driver uses an application on a supervising driver's mobile device to obtain a verification of an age of the supervising driver from the department of motor vehicles, and wherein the one-time verification includes sending from the biometric device, the verified biometric identification of the supervising driver that is stored in the blocking device.

4. The computer-implemented method of claim 1, wherein the first biometric identification and the verified biometric identification of the supervising driver are a fingerprint.

5. The computer-implemented method of claim 1, wherein the first biometric identification and the verified biometric identification of the supervising driver are one of a retinal scan, a facial image, or a voice.

6. The computer-implemented method of claim 4, wherein determining whether the first biometric identification matches the verified biometric identification of the supervising driver includes using fingerprint analysis algorithms to determine whether the first biometric identification matches the verified biometric identification of the supervising driver.

7. The computer-implemented method of claim 1, wherein unblocking the ignition circuit of the vehicle further comprises allowing, by one or more computer processors, the vehicle of the novice driver to start with the supervising driver present when the novice driver initiates the ignition circuit of the vehicle.

8. A computer program product for preventing an ignition of a vehicle of a novice driver when a supervising driver is not present, the computer program product comprising:
one or more computer readable storage media; and
program instructions stored on the one or more computer readable storage media, the program instructions comprising instructions to perform:
blocking an ignition circuit of a vehicle;
receiving a first biometric identification of a supervising driver;
determining whether the first biometric identification matches a verified biometric identification of the supervising driver stored in a blocking device; and
responsive to determining that the first biometric identification matches the verified biometric identification of the supervising driver stored in the blocking device, unblocking the ignition circuit of the vehicle.

9. The computer program product of claim 8, wherein the stored biometric identification is received as a part of a one-time verification of the supervising driver from a government entity controlling driver licensing.

10. The computer program product of claim 8, wherein the first biometric identification and the verified biometric identification of the supervising driver are a fingerprint.

11. The computer program product of claim 8, determining whether the first biometric identification matches the verified biometric identification of the supervising driver includes using fingerprint analysis algorithms to determine whether the first biometric identification matches the verified biometric identification of the supervising driver.

12. The computer program product of claim 8, wherein unblocking the ignition circuit of the vehicle further comprises allowing the vehicle of the novice driver to start when the supervising driver is present.

13. The computer program product of claim 8, further comprising:
querying a clock module;
determining whether an unblock time as expired; and
responsive to determining that the unblock time has expired, blocking the ignition circuit of the vehicle.

14. A blocking device, the device comprising:
one or more computer processors;
a novice driver program;
at least one biometric device;
a computer data storage; and
a clock module.

15. The blocking device of claim 14, wherein the blocking device connects to an ignition circuit of a vehicle of the novice driver.

16. The blocking device of claim 14, wherein the novice driver program blocks an ignition circuit until determining that a department of motor vehicle verified experienced driver is present in the vehicle.

17. The blocking device of claim 14, wherein the at least one biometric device includes a fingerprint scanner in a front passenger side of a vehicle of the novice driver.

18. The blocking device of claim 14, wherein the computer data storage includes at least one at least one verification of one or more experienced drivers with a required age from a department of motor vehicles as a supervisory adult for the novice driver and a biometric identification associated with the one or more experienced drivers with a required age verified by a department of motor vehicles.

19. The blocking device of claim 14, wherein the clock module tracks a time of day.

20. The blocking device of claim 14, wherein the novice driver program is pre-set with one or more required times of day when the novice driver requires supervision.
